(19) United States
(12) Patent Application Publication
(10) Pub. No.: US 2002/0161644 A1
(43) Pub. Date: Oct. 31, 2002

(54) Cooperative incentive and promotion system and method for use on a computer networking system

(76) Inventor: George Duffield, Marietta, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/113,376

(22) Filed: Mar. 29, 2002

Related U.S. Application Data
(60) Provisional application No. 60/280,725, filed on Mar. 31, 2001.

(51) Int. Cl. G06F 17/60

(52) U.S. Cl. 705/14; 705/40

(57) ABSTRACT

A cooperative incentive and promotion system and method encouraging subscription to electronic presentment and payment (EPP) vendor services, such as electronic bill presentment and payment (EBPP) and/or electronic statement presentment (ESP) services, wherein a consumer engaging in a bill paying or printed statement review process is induced to access a global networking system, such as the Internet, during that process. Positive inducement is provided on a bill or statement envelope, a remittance envelope, directly on the bill or statement or on an insert therewith, wherein a sweepstakes offer, coupon or discount offer promoting a specific business, product or service is prominently displayed, wherein access to the Internet is required and utilized for receipt thereof, and wherein coincident promotion of EBPP and/or ESP subscription is provided.

### CROSS-REFERENCE TO RELATED APPLICATIONS

To the full extent permitted by law, the present application claims priority to and the benefit as a non-provisional application to provisional patent application entitled “Cooperative Incentive and Promotion Method for Use on a Computer Networking System” filed on Mar. 31, 2001, having assigned Ser. No. 60/280,725, wherein said application is incorporated herein by reference.

### TECHNICAL FIELD

The present invention relates generally to advertising methods and, more specifically, to a cooperative incentive and promotion system and method encouraging subscription to electronic presentment and payment (EPP) vendor services, such as electronic bill presentment and payment (EBPP) and/or electronic statement presentment (ESP) services, by offering selected rewards, wherein access to a global networking system such as the Internet is utilized for receipt thereof.

### BACKGROUND OF THE INVENTION

North American companies and financial entities presently generate 23 billion recurrent bills each year. Worldwide, it is reported that the annual number of such repetitively printed materials is a staggering 60 billion. Recognizing the inherent costs of continually providing printed statements and bills, along with the technological advancements enabling the availability of electronic alternatives thereto, businesses have funded and supported the development of an infrastructure for electronic bill payment and statement presentment. Unfortunately, consumers have not enthusiastically embraced these systems.

One method that some companies utilize to defray the expense of printing recurring bills and statements is to include product advertising inserts therewith. This approach attempts to maximize the return on the already committed costs of postage and printing by selling additional products or services. Unfortunately, many consumers have become jaded to such inserts and remove the invoice or statement without examining the accompanying literature.

A similar method utilizes a return envelope with a perforated advertisement attached thereto, wherein removal of the leaflet is necessary in order to seal and use the envelope. This insures that the consumer will have some degree of direct contact with the information, but only if the envelope is needed. Thus, the method is unable to be successfully undertaken by institutions providing informative statements only, wherein no response thereto is indicated. Moreover, the underlying costs of issuing recurrent paper billings and statements remain.

Some businesses find the cost of continued paper billings so unacceptable that they have taken direct action to strongly encourage consumers to utilize electronic billing methods, wherein a penalty is assessed to the customer for each bill that must be printed and mailed. It is doubtful that many would deny the negative image these types of disadvantageous tactics paint in the mind of the average consumer.

Others have committed large marketing budgets to the direct promotion of EBPP and ESP services. Unfortunately, consumer response has not been forthcoming, even despite such marketing expense. Thus, some bill and statement providers are hesitant to allocate a significant EBPP and ESP promotional marketing budget.

Moreover, customer satisfaction and business economic matters are not the only concerns. Environmental issues are posed by the endless production of printed materials. For instance, millions of direct mail advertising flyers are distributed each month, in addition to printed bills and statements. Unintentionally contributing to waste management concerns, a large percentage of direct mail advertisements are immediately discarded, thus failing to influence their targeted audiences and resulting in a disadvantageously inefficient advertising strategy.

Therefore, it is readily apparent that there is a need for a cooperative incentive and promotion method wherein subscription to electronic bill presentment and payment (EBPP) and electronic statement presentment (ESP) services is encouraged by offering specific advertiser rewards, thereby reducing the number of printed bills and statements produced by one participating business interest; by enabling promotion of EBPP and ESP services while reducing or eliminating marketing expenditures therefore, often enabling a positive revenue stream therefrom; by also providing an economical, environmentally sound advertising format for a second participating business or service, thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a cooperative incentive and promotion system and method encouraging subscription to electronic bill presentment and payment (EBPP) and/or electronic statement presentment (ESP) services by offering selected rewards, wherein access to a global networking system such as the Internet is utilized for receipt thereof.

According to its major aspects and broadly stated, the present invention is a system and method of accelerating customer support for EBPP and ESP services and coincidingly encouraging customer selection of a product or service, thereby reducing the number of printed bills and statements produced by a first business while providing an economical, environmentally sound advertising format for a second business and increasing service utilization and resulting value growth of a third business.

More specifically, the present invention in its preferred form is a system and method to induce a consumer engaging in a bill paying or printed statement review process to access a global networking system, such as the Internet, during that process. Positive inducement is provided on any bill or statement envelope, remittance envelope, directly on the bill or statement, or on an insert therewith, wherein a coupon, discount, or sweepstakes offer promoting a specific business, product or service is prominently displayed. While any type of reward may be utilized, the offer is preferably for a product or service that is complementary to the billing company. For example, an automobile invoice may provide incentives for automobile parts retailers. In order to activate the coupon or offer and receive any benefit therefrom, the consumer is required to access a global networking system, such as the Internet, as printed and directed thereon.

Upon accessing the specified portal, the consumer follows a link to an advertiser's portal to redeem the coupon, receives a code for redemption at a later time or prints a coupon for redemption at a locally operated site. A second link to the EBPP or ESP site of the provider responsible for generating the bill or statement is provided on the advertiser's and/or host's page. The provider may incorporate an additional incentive therein, whereby selection of the EBPP or ESP site and subsequent subscription thereto enables a discount reducing the total payment due by the consumer.

The cooperative incentive and promotion system and method foresees at least four direct beneficiaries, including the consumer, the billing and statement provider, the electronic presentment and payment vendor (EPP) including EBPP and/or ESP solutions providers, and the advertiser. Each cooperative business participant appreciates both short-term and long-term profits, as does the consumer. First, the consumer benefits immediately by receiving discounted products and services but also gains long-term advantages from subscribing to EBPP and/or ESP services, such as, for exemplary purposes only, reduced record keeping and budget management tasks and time expenditures.

A bill or statement provider, such as, for exemplary purposes only, a mortgage company, car insurance carrier, financial service provider or telecommunications company, receives direct compensation generated from cooperative advertising revenues for participating in the herein disclosed system, thus immediately reducing the cost of paper billing while effectively promoting their EBPP and/or ESP service, providing their customer with a positive brand experience and thanking their customer with a tangible reward. The company also gains long-term advantages, such as a reduction in customer service calls, improved customer retention and increased traffic to its web site, thus providing opportunities to cross-sell other goods and services to the customer. Finally, the billing or statement provider obtains a method to directly monitor consumer behavior and response to the cooperative incentive and promotion method, thereby enabling direct response thereto.

The EPP or electronic presentment and payment vendor, whether an EBPP or ESP solutions provider, benefits from the acceleration of customer subscription to electronic bill payment and the resulting business growth. In fact, while billing and statement providers may be frustrated by a lack of consumer subscription to electronic bill payment, the failure of consumers to embrace such systems directly limits the success of EPP vendors. EPP vendors typically receive transaction fees from the bill or statement provider for each customer that utilizes the EPP system for account access, monitoring and/or payment. This recurring monthly fee can help to build stockholder valuation for the EPP vendor. Thus, increased utilization of electronic bill payment systems directly impacts the long-term success of EPP vendors.

The fourth direct beneficiary of the cooperative incentive and promotion method is an advertising sponsor, such as, for exemplary purposes only, a home supply company, auto service company or travel industry providers such as an airline, car rental company or hotel. The advertiser receives advertising at a fraction of the cost of direct mail, eliminating all postage costs, wherein the effectiveness surpasses that of direct mail. The cooperative incentive and promotion method offers the advertiser greater exposure than direct mail. Since the advertisement is positioned on a billing or remittance envelope, insert, bill or statement, it is not likely to be immediately thrown away. In fact, since the average consumer waits approximately two weeks before paying a bill, it is likely that he or she will see the advertisement at least two or three times. Other benefits for the advertiser include an implied endorsement from the billing entity, an ability to directly monitor the success of the ad and, wherein the coupon relates to a web site, increased traffic thereto providing opportunities to cross sell other goods and services to the customer.

A feature and advantage of the present invention is the ability of such a system and method to encourage subscription to EBPP and/or ESP services.

A feature and advantage of the present invention is the ability of such a system and method to enable cooperation of two or more independent business organizations, wherein each benefits therefrom.

A feature and advantage of the present invention is the ability of such a system and method to provide consumer incentives and promotions, wherein access to a global networking system such as the Internet is utilized for receipt thereof.

A feature and advantage of the present invention is the ability of such a system and method to reduce the number of printed bills and statements produced by a first business, while providing an economical, environmentally sound advertising format for a second business.

A feature and advantage of the present invention is the ability of such a system and method to reduce the number of printed bills and statements produced by a first business, while providing an economical, environmentally sound advertising format for a second business and increasing the gross revenue of a third business.

A feature and advantage of the present invention is the ability of such a system and method to induce a consumer engaging in a bill paying or printed statement review process to access a global networking system, such as the Internet, during that process.

A feature and advantage of the present invention is the ability of such a system and method to provide an immediate reduction in paper billing costs for participating businesses.

A feature and advantage of the present invention is the ability of a participating business to receive compensation for the right to promote and accelerate consumer adoption of its EBPP and ESP services.

A feature and advantage of the present invention is the ability of a participating business to receive revenue from cooperative advertising, thereby supplementing a marketing budget and/or generating a revenue stream, wherein coincident thereto, EBPP and/or ESP services are promoted.

A feature and advantage of the present invention is the ability of such a system and method to provide customers with a positive brand experience.

A feature and advantage of the present invention is the ability of such a system and method to enable a business to thank their customers with a tangible reward.

A feature and advantage of the present invention is the ability of such a system and method to provide participating businesses with long-term advantages, such as, for exemplary purposes only, a reduction in customer service calls, improved customer retention and increased web site traffic.

A feature and advantage of the present invention is the ability of such a system and method to provide a business with postage free, high-exposure promotional advertising.

A feature and advantage of the present invention is the ability of such a system and method to provide an advertiser with the implied endorsement of the biller or financial service provider.

A feature and advantage of the present invention is the ability of such a system and method to enable an advertiser to directly monitor the success of an ad.

A feature and advantage of the present invention is the ability of such a system and method to enable a billing or statement provider to directly monitor consumer behavior and response to the cooperative incentive and promotion method, thereby enabling direct response thereto.

A feature and advantage of the present invention is the ability of such a system and method to enable analysis of consumer behavior while engaged in the bill paying process, wherein customer service staffing and other demographic responses can be supported.

A feature and advantage of the present invention is the ability of such a system and method to enable a billing and statement provider to directly monitor the number of hits to both the landing page with the incentive, as well as the number of click-throughs to the e-bill enrollment page.

A feature and advantage of the present invention is the ability of such a system and method to increase consumer subscription to and reliance on EBPP and EBP services, decreasing the tremendous volume of repetitive statement and billing mailings handled by the U.S. Postal Service, ultimately assisting in the effective application of increased security measures thereby.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a plan view of a printed inducement and promotion offer according to a preferred embodiment of the present invention, showing a billing envelope with a cooperative inducement and promotion offer printed on the exterior rear flap and surface thereof.

FIG. 2 is a plan view of the printed inducement and promotion offer of FIG. 1, showing a remittance envelope with a cooperative inducement and promotion offer printed on the exterior rear flap and surface thereof.

FIG. 2A is a view of a video display terminal having a host web page with a cooperative inducement and promotion offer displayed thereon, according to a preferred embodiment of the present invention.

FIG. 2B is a view of a video display terminal having a billing provider web page with links to EPP vendors displayed thereon, according to a preferred embodiment of the present invention.

FIG. 3 is a flowchart of a system and method for inducing consumer subscription to EPP vendor services according to a preferred embodiment of the present invention, wherein an inducement and promotion offer is printed on an exterior of an outside envelope.

FIG. 3A is a flowchart of a system and method for inducing consumer subscription to EPP vendor services, wherein an inducement and promotion offer is printed on an inside flap of an outside envelope.

FIG. 3B is a flowchart of a system and method for inducing consumer subscription to EPP vendor services, wherein an inducement and promotion offer is printed on an inside flap of a remittance envelope.

FIG. 3C is a flowchart of a system and method for inducing consumer subscription to EPP vendor services, wherein an inducement and promotion offer is printed on an exterior of a remittance envelope.

FIG. 4 is a flowchart of a system and method for inducing consumer subscription to EPP vendor services, wherein an inducement and promotion offer is printed on a bill, statement or insert.

FIG. 5 is a flowchart of a preferred method of establishing the cooperative inducement and promotion system and method of FIG. 3.

FIG. 6 is a flowchart of a preferred method of compensation for the cooperative inducement and promotion system and method of FIG. 3.

FIG. 7 is a flowchart of a method of compensation for a cooperative inducement and promotion system and method, according to an alternate embodiment of the present invention.

FIG. 8A is a view of a monthly activity report displayable on a video display terminal.

FIG. 8B is a view of a daily activity report displayable on a video display terminal.

FIG. 8C is a view of an hourly activity report displayable on a video display terminal.

FIG. 8D is a view of a data access point displayable on a video display terminal.

### DETAILED DESCRIPTION OF THE PREFERRED AND ALTERNATE EMBODIMENTS

In describing the preferred and alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

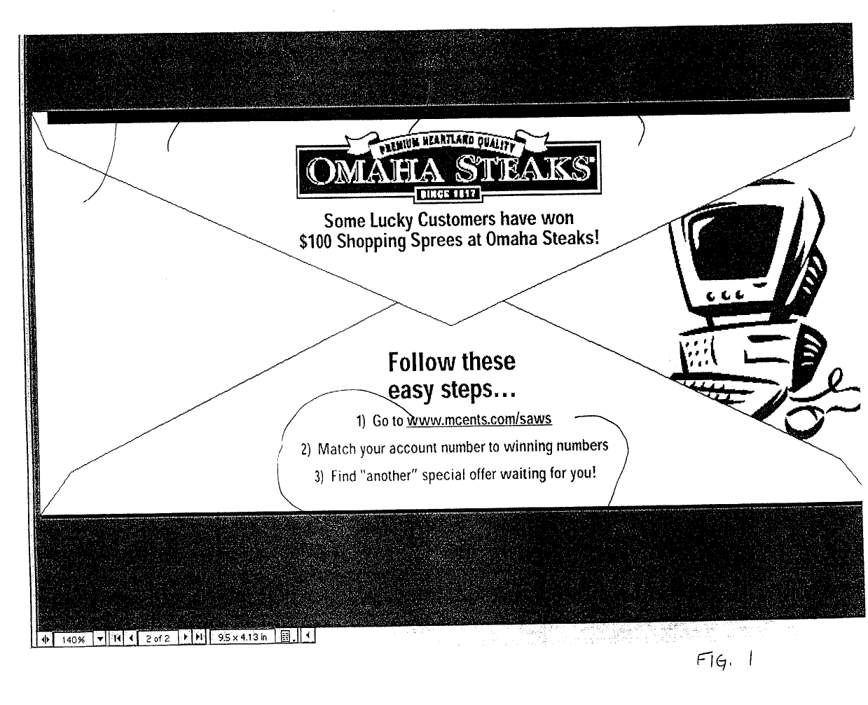

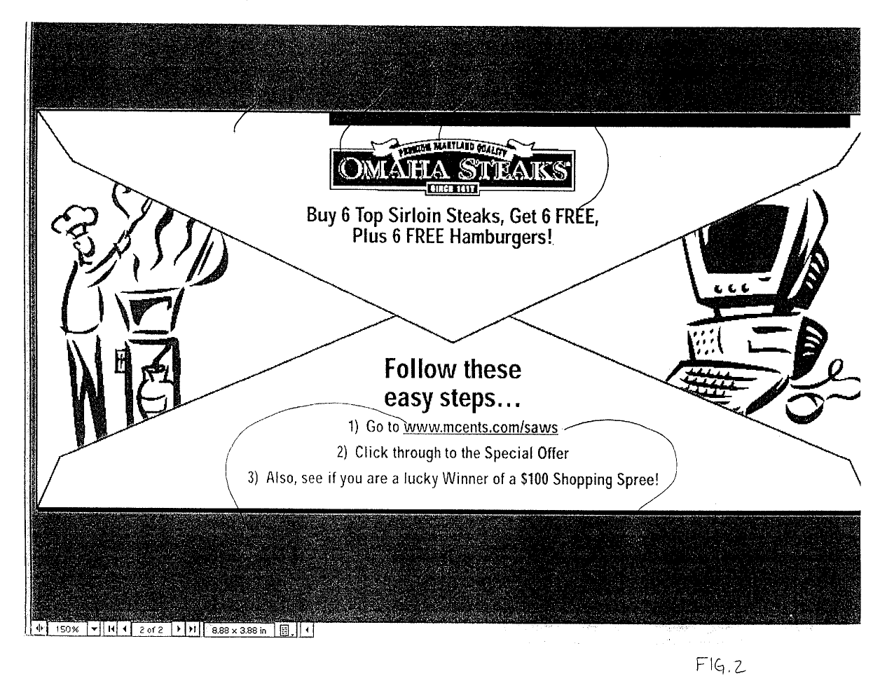

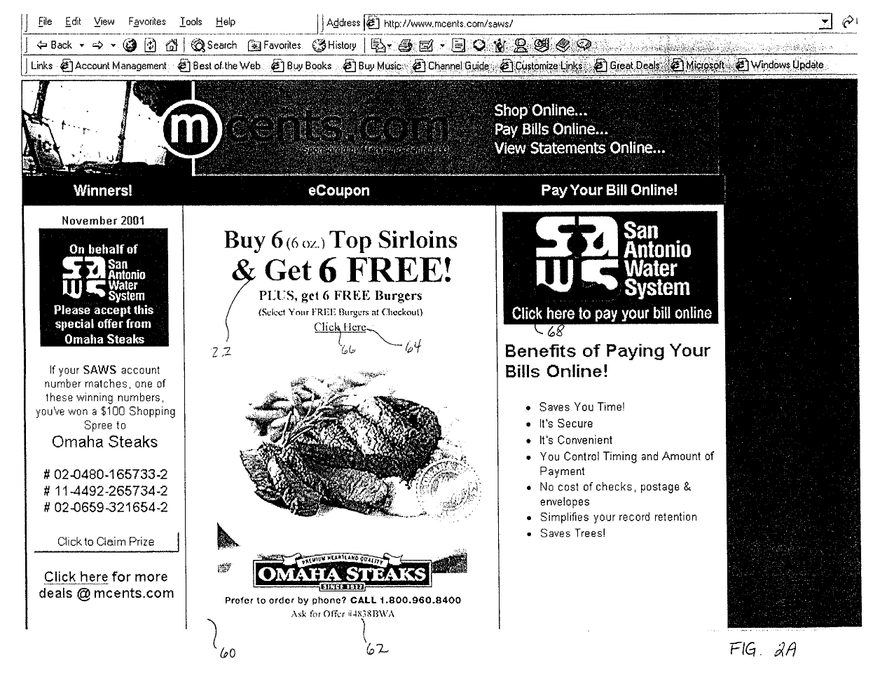

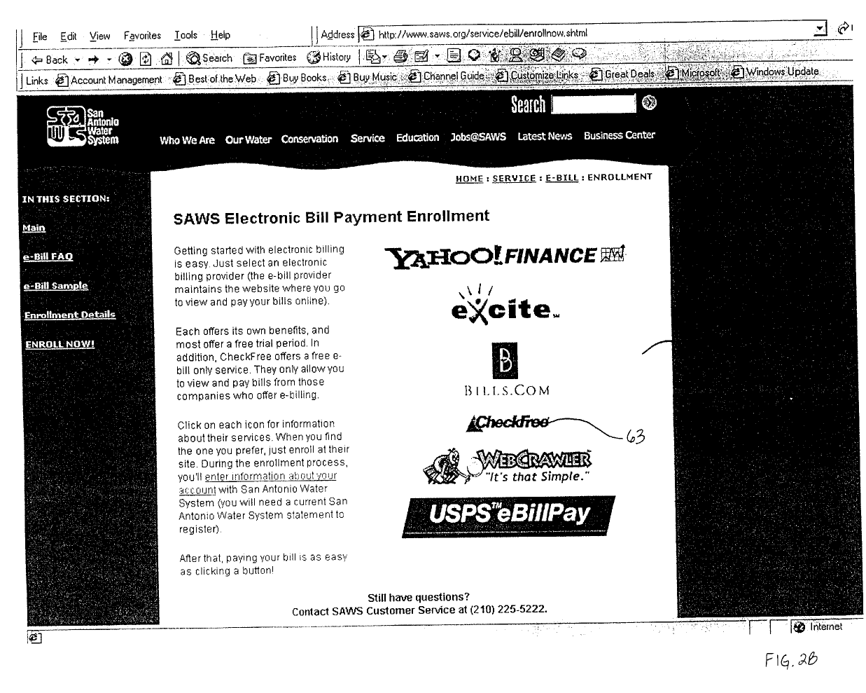

Referring now to FIG. 1, the present invention is a cooperative incentive and promotion system and method 10 for use on a computer networking system, such as the Internet, wherein cooperative incentive and promotion system and method 10 induces consumer subscription to electronic presentment and payment (EPP) services, such as electronic bill presentment and payment (EBPP) and/or electronic statement presentment (ESP) services, wherein at least one reward 20 is offered and wherein access to a global networking system such as the Internet must be utilized for receipt thereof. One skilled in the art would readily recognize that, while one reward 20 may be sufficient to induce a consumer to access a global networking system, a plurality of rewards may also be utilized, wherein the combination thereof provides consumer inducement, thereby performing as a functional equivalent to one such reward. For example, as seen in FIG. 2, preferably complementary reward 21 may be provided on remittance envelope 41, wherein reward 20 could be provided on billing envelope 40. However, while complementary reward 21 is preferred, any reward 20 may be utilized for complementary reward 21, wherein the descriptions of reward 20 and complementary reward 21 may be mutually applied.

Preferably, reward 20 is discount offer 22 redeemable towards the purchase of a specified product or service, as best seen in FIG. 2. One skilled in the art would readily recognize that while a specified value credit voucher 24 is the preferred form of discount offer 22, other types of promotional rewards could be utilized, such as, for exemplary purposes only, specified percentage price reduction coupons, point or mileage vouchers for frequent travel clubs, certificates for free collectable toys or novelties, entertainment ticket vouchers, sweepstakes entries (such as is shown in FIGS. 1-2), randomly variable range of rewards, or a choice or combination thereof.

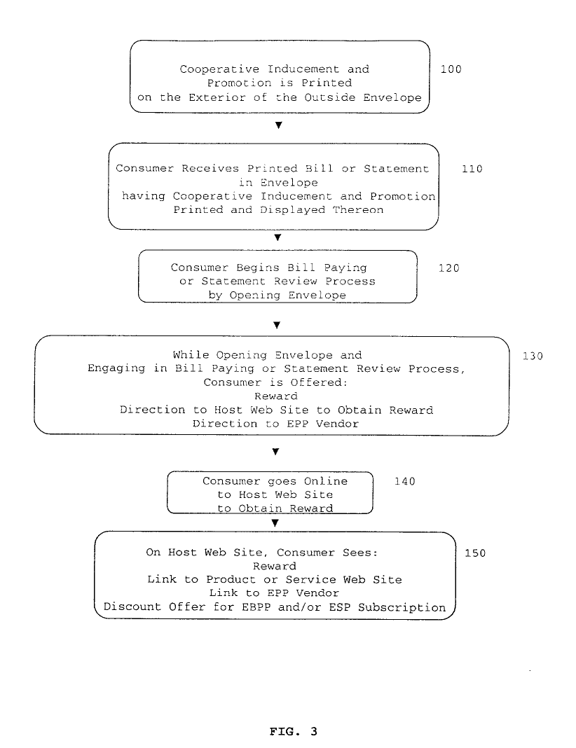

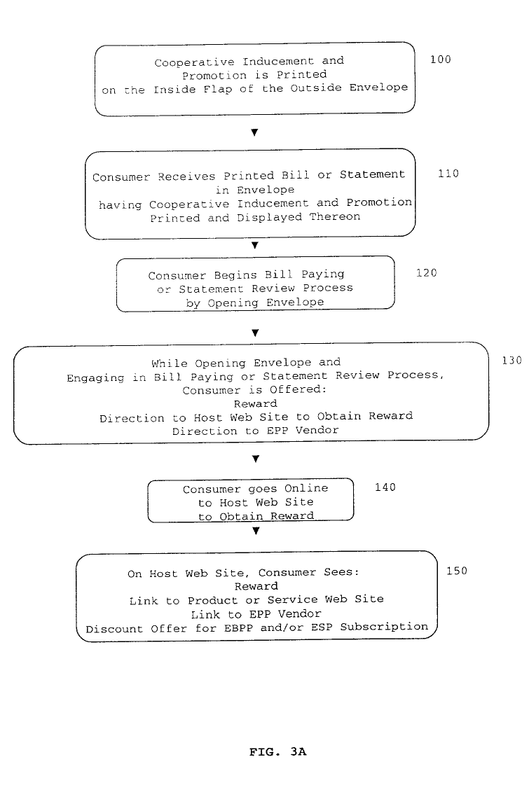

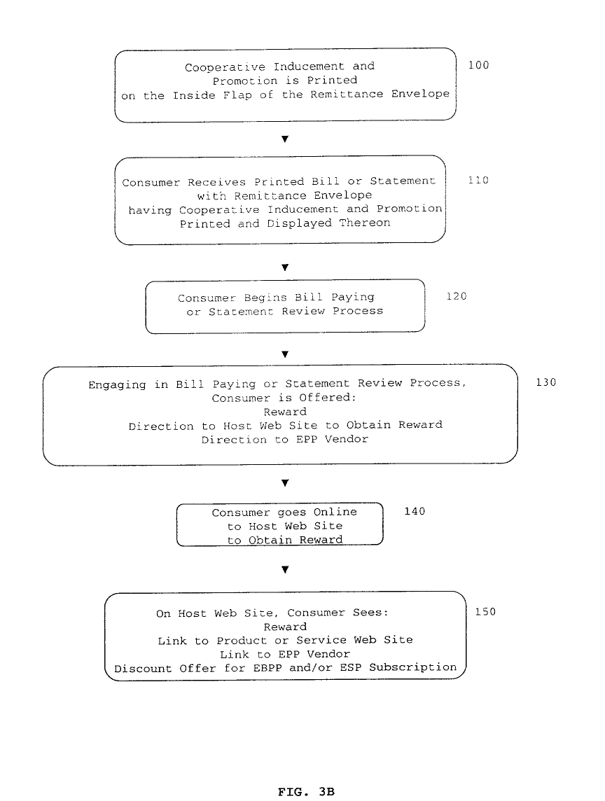

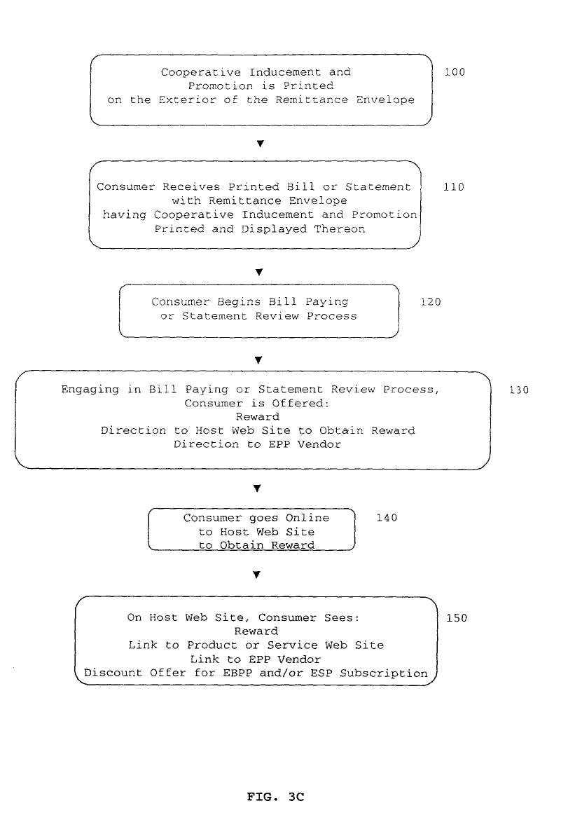

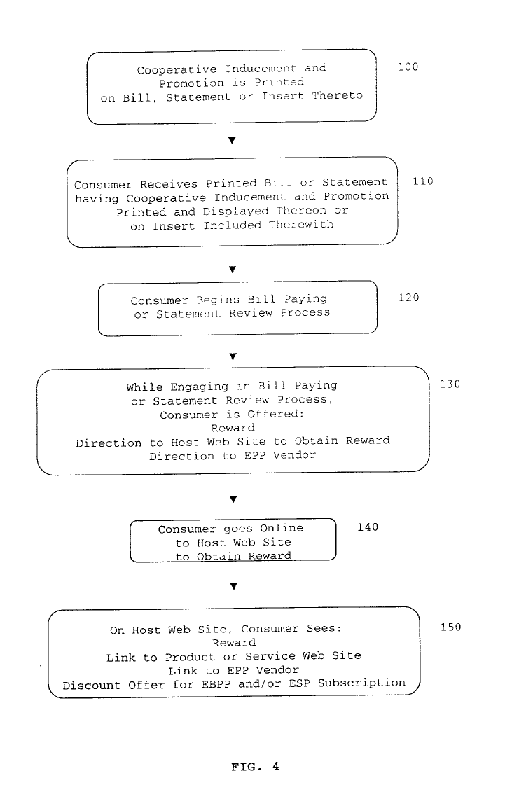

Preferably, offer 22 is printed on rear flap 42 of envelope 40, as shown in FIG. 1, wherein a bill, invoice or statement issued by the EBPP and/or ESP provider is carried therein. Preferably, instruction 28 is printed proximate to offer 22, wherein instruction 28 provides first uniform resource locator (URL) 30, wherein access thereto, via a global networking system such as the Internet, encourages and enables consumer subscription to the EPP vendor service of the bill, invoice or statement provider. One skilled in the art would readily recognize that while rear flap 42 of envelope 40 is the preferred location for printing offer 22 and instruction 28, other positions could be utilized, such as, for exemplary purposes only, rear surface 44 of envelope 40, interior flap of envelope 40, a surface of the bill or statement carried within envelope 40, a surface of an insert provided therewith, a surface of a remittance envelope or any other surface or combination thereof, some of which are shown in FIGS. 3, 3A, 3B, 3C and 4.

Preferably, access to offer 22 specified URL 30, via a global networking system such as the Internet, is required to activate offer 22 and receive any benefit therefrom. Preferably, URL 30 directs the consumer to web page 60, as seen in FIG. 2A. Web page 60 preferably displays offer 22, wherein a redeemable coupon 62, discount offer, or sweepstakes entry may be printed therefrom. Preferably, web page 60 also displays second URL 64 as first hyperlink 66, wherein selection thereof directs the consumer to a web site of the sponsor of offer 22 for immediate redemption thereof. One skilled in the art would readily recognize that, while it is preferred that first hyperlink 66 direct the consumer to second URL 64, second URL 64 could be displayed for manual input by a consumer.

Wherein the consumer elects to postpone redemption of offer 22, a single-use reward code is preferably provided to enable future reference thereto and activation thereof. Wherein offer 22 is a randomly variable range of rewards, consumer access to web page 60 reveals a reward randomly selected from a predetermined range of possible and specified rewards.

Preferably, web page 60 displays second hyperlink 68, wherein selection thereof directs the consumer to a web site 61 of the billing and statement provider, as seen in FIG. 2B, preferably with links 63 to an EPP vendor, bank, brokerage or web portal, thereby encouraging subscription to services thereof.

Preferably, subscription incentive 70 (not shown) is also provided and functions as a reward 20, whereby selection of the EPP vendor site and subsequent subscription to the services thereof enables a discount reducing the debt of the consumer, a bonus to the positive balance, such as of frequent flier mileage, thereof, or other appropriate reward system.

As best seen in FIG. 3, the first step 100 in the cooperative incentive and promotion system and method 10 for inducing consumer subscription to electronic presentment and payment (EPP) vendor services, such as electronic bill presentment and payment (EBPP) and/or electronic statement presentment (ESP) services, wherein at least one reward 20 is offered and wherein access to a global networking system such as the Internet must be utilized for receipt thereof, is preferably printing the cooperative inducement and promotion offer on envelope 40. Second step 110 is preferably the consumer's receipt of envelope 40 with a bill or statement provided therein and reward 20 printed thereon, thereby enabling a first consumer viewing and awareness thereof.

The consumer begins the bill paying and/or statement review process by opening envelope 40 in preferred step 120. While engaged in the bill paying and/or statement review process, consumer sees printed reward offer 20 in step 130. To accept reward offer 20 and receive benefit thereof, in step 140 of cooperative incentive and promotion system and method 10, consumer accesses a global networking system such as the Internet and preferably proceeds to URL 30, as directed. Preferably, in step 150 of cooperative incentive and promotion system and method 10, upon accessing web page 60, the consumer views and receives credit voucher 24 and also views hyperlink 66 encouraging subscription to EPP vendor services, such as EBPP and/or ESP.

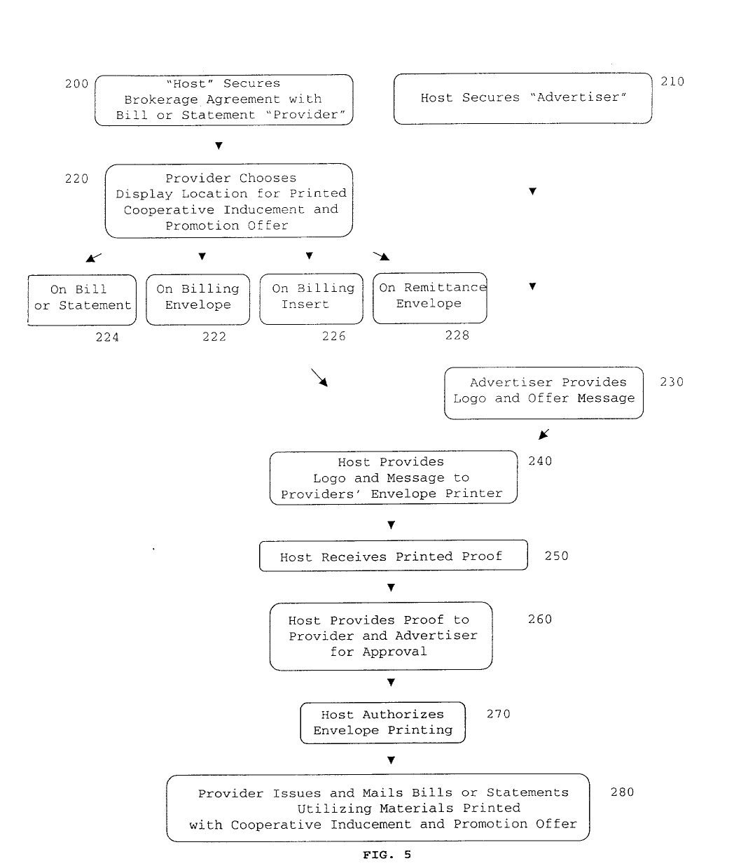

As best seen in FIG. 5, the preferred method of establishing the cooperative inducement and promotion system and method 10 described herein is initiated with a marketing host (Host) securing a brokerage agreement with a bill or statement provider (Provider) 200. Preferably, the brokerage agreement is exclusive, however, one skilled in the art would readily recognize that other types and degrees of agreements could be utilized. Preferably, Provider receives compensation for participating in the cooperative inducement and promotion system and method 10. Host also secures promotional sponsorship (Advertiser) 210, wherein preferably Advertiser is subjected to a fee for participation.

Preferably, Provider chooses the display location for the printed offer 220, either the preferred outside envelope location 222, on the bill or statement 224, on an insert 226 or on a remittance envelope 228. Following notification as to the selected location for the display of offer 20, Advertiser provides an appropriately selected offer message and logo 230, wherein Host forwards the message and logo to Provider's envelope printer 240.

Preferably, Host receives printing proof 250 and forwards the proof to Provider and Advertiser for final approval 260. Following receipt of such approval, Host preferably authorizes envelope printing to proceed 270. Finally, Provider issues and mails bills or statements utilizing envelopes printed with cooperative inducement and promotion offer printed thereon 280 and the method of encouraging consumers to subscribe to EPP vendor service is initiated.

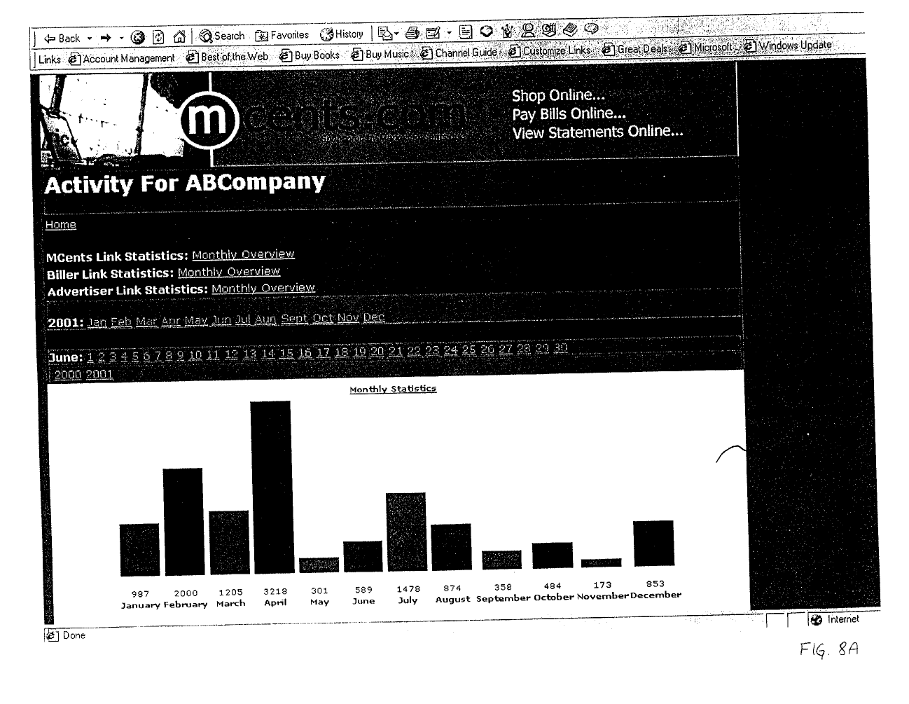

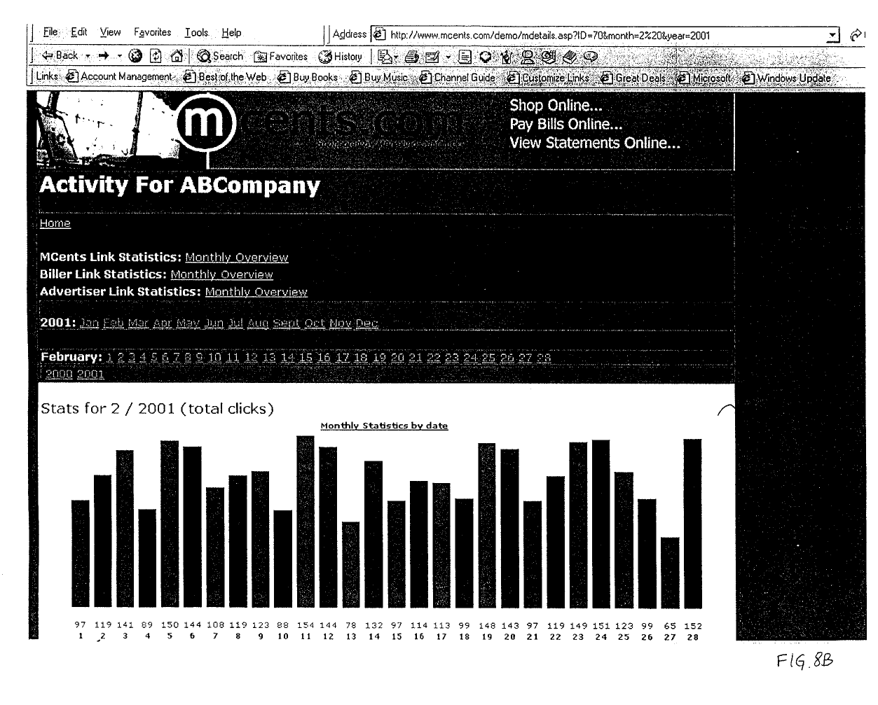

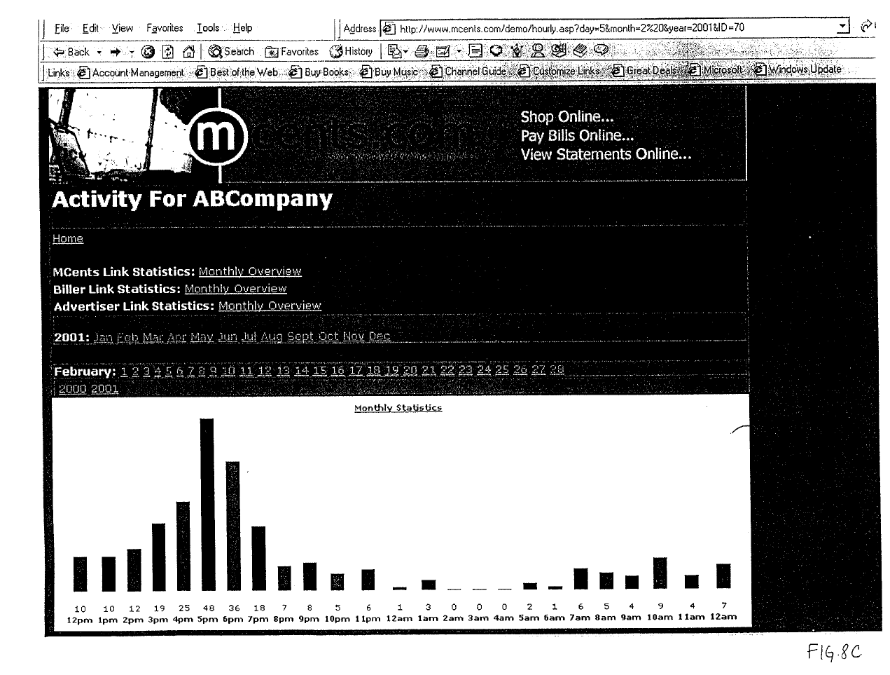

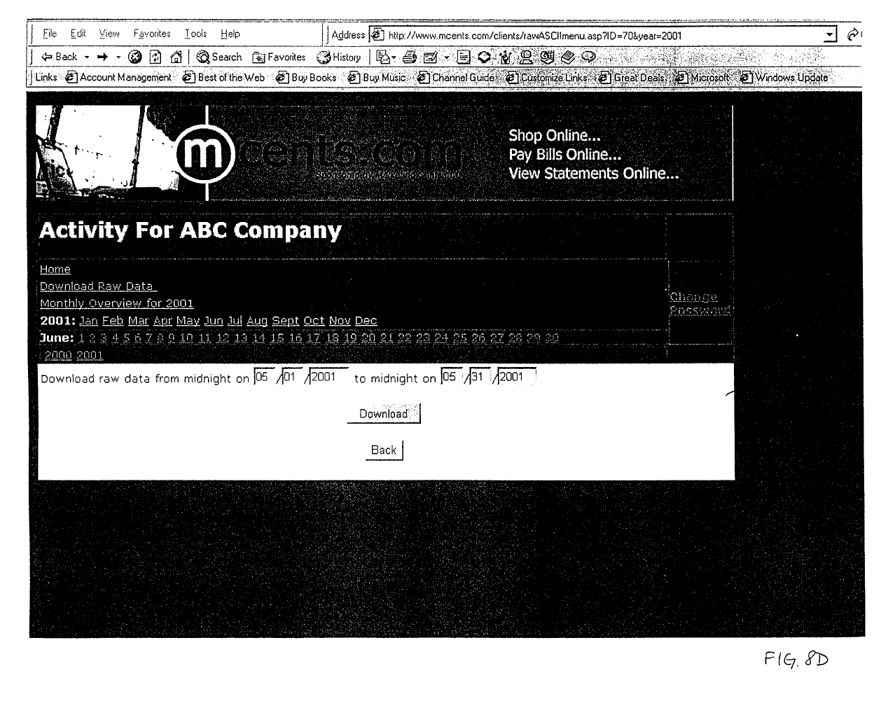

Preferably, cooperative incentive and promotion system and method 10 for inducing consumer subscription to EPP vendor services, such as EBPP and/or ESP enables Provider, Advertiser, EPP vendor or other authorized user to directly monitor the success of cooperative incentive and promotion system and method 10, wherein consumer behavior and response to the cooperative incentive and promotion system and method 10 can preferably be tracked, thereby enabling direct response thereto and wherein such data preferably remains confidential. As best seen in FIGS. 8A, 8B, 8C and 8D, an authorized system user can preferably monitor the number of hits to both the landing page with the incentive, as well as the number of click-throughs to the e-bill enrollment page. Preferably, the data can be viewed in monthly report format 400, as in FIG. 8A, in daily report format 410, as in FIG. 8B, or in hourly report format 420, as in FIG. 8C. Also preferably, as shown in FIG. 8D, raw data 430 can be downloaded by an authorized user, wherein such data can be transferred and analyzed via a known spreadsheet program or any other type of desired or otherwise appropriate program. One skilled in the art would readily recognize that, while the foregoing is the preferred embodiment for the display and access to the data, any format, display, program or available transfer method could be utilized without departing from the intended scope of the present system and method, moreover, additional data elements could also be tracked and reported.

Data obtained, such as in hourly report format 420, can preferably be utilized to enable analysis of consumer behavior while engaged in the bill paying process, wherein customer service staffing and other demographic responses can be supported. For example, Provider may note select times on a select day or days wherein activity is increased, and Provider may respond to such increased system utilization by staffing customer service telephone lines or e-mail communication systems accordingly.

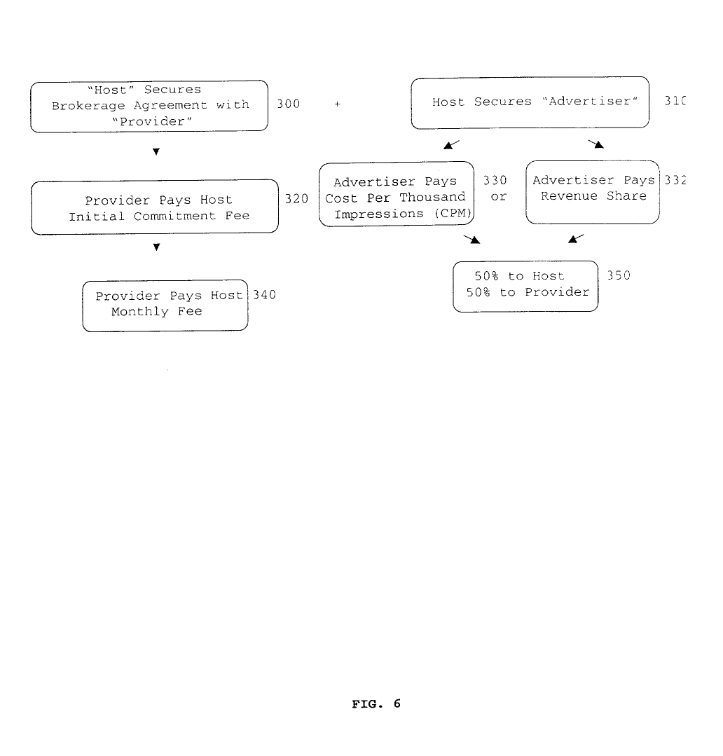

As best seen in FIG. 6, the preferred method of compensation for participants of cooperative incentive and promotion system and method 10 for inducing consumer subscription to EPP vendor services, such as EBPP and/or ESP, begins with Host securing a brokerage agreement with Provider 300 and with Host securing an agreement with Advertiser 310. Provider preferably pays Host an initial commitment fee 320, wherein the commitment fee is preferably derived from an estimated number of bills to include reward 20. For example, if Provider estimates one million bills per month, an initial commitment fee of $.01 per bill could be assessed, for a total initial commitment fee of $10,000. Preferably, Provider pays Host a monthly fee 340, again based on the number of bills generated per month. For example, if Provider generates one million bills or statements per month, a fee of $.001 per bill could be assessed, for a total monthly bill of $1000.00. One skilled in the art would readily recognize that other amounts and/or methods of assessment could be utilized without departing from the intended scope of the system and method presented herein, moreover, the commitment fee and/or the monthly fee could be removed as an obligation for the Provider.

Advertiser preferably pays Host an advertising fee, wherein such fee is preferably based on cost per thousand impressions (CPM) 330 or revenue share 332. CPM is an easy to calculate method, wherein a flat fee is charged per impression, or printed advertisement. For example, if advertisement is displayed on one million bills or statements per month and the charge is $.01 per impression, Advertiser pays Host $10,000. Preferably, Host shares this revenue with Provider, wherein a 50/50 split is preferred. Thus, for example, for one million bills, Provider pays Host $1,000, but receives $5,000 in shared advertising revenue, resulting in a net gain of $4,000. Thus, Provider receives EBPP and/or ESP promotion not only without budget expenditures, but realizes a direct profit therefrom. One skilled in the art would readily recognize that, while the described advertising fee share approach is preferred, other amounts and/or methods of assessment could be utilized without departing from the intended scope of the method presented herein.

Unlike CPM, revenue share advertising fees are performance based, are obligated and generated only upon success of the advertisement, and are preferably a percentage of revenue realized by Advertiser. For example, if an advertisement is displayed on one million bills or statements per month and one thousand consumers respond with an average $60 purchase, Advertiser would realize $60,000 in revenue. A 5% revenue share would generate $3,000 in advertising fees payable to Host, wherein Host shares this revenue with Provider. Thus, for the example given, Provider pays Host $1,000, but receives $1,500 in shared advertising revenue, resulting in a net gain of $500. Again, effective EBPP and ESP promotion is achieved and there is a profit in lieu of an expenditure.

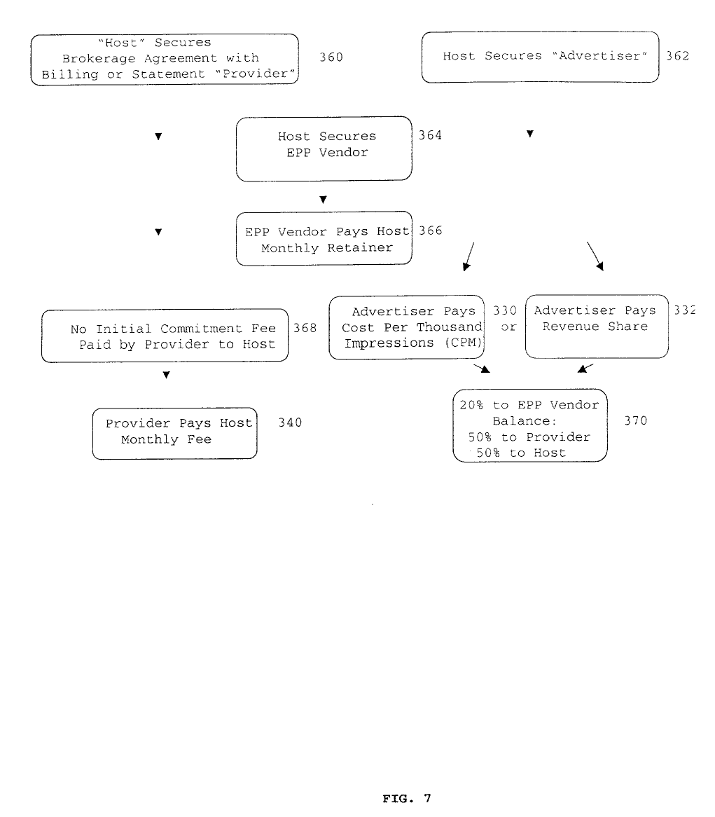

As best seen in FIG. 7, an alternate method of compensation for participants of cooperative incentive and promotion system and method 10 for inducing consumer subscription to EPP vendor services, such as EBPP and/or ESP, 10 could begin with Host securing a brokerage agreement with Provider 360, with Host securing an agreement with Advertiser 362, and with Host securing an agreement with EPP Vendor 364. EPP Vendor could pay Host a monthly retainer fee 366, whereby an initial commitment fee could not be required from Provider 368. Another embodiment could provide for a reduction of the commitment fee from Provider.

Provider could pay Host a monthly fee 340, based on the number of bills generated per month. For example, if Provider generates one million bills or statements per month, a fee of $.001 per bill could be assessed, for a total monthly bill of $1000.00. One skilled in the art would readily recognize that other amounts and/or methods of assessment could be utilized without departing from the intended scope of the method presented herein.

As described above, Advertiser could pay Host an advertising fee 330, 332 wherein such fee is preferably based on cost per thousand impressions (CPM) 330 or revenue share 332. Host could share this revenue with EPP Vendor, such as in a 20% revenue share arrangement, wherein Host could then share the net revenue with Provider, such as in a 50/50 split. Thus, for example, for five million bills with a monthly advertising revenue of $32,500, Host could share $6500 with EPP Vendor, and Provider and Host could each receive $13,000 in shared advertising revenue. One skilled in the art would readily recognize that other amounts and/or methods of assessment could be utilized without departing from the intended scope of the method presented herein.

In an alternate embodiment, a plurality of rewards 20 could be utilized, wherein a choice therebetween or a combination thereof could provide consumer inducement.

In an alternate embodiment, reward 20 could be a specified percentage price reduction coupon.

In an alternate embodiment, reward 20 could be a point or mileage voucher for a frequent travel clubs, such as, for exemplary purposes only, airline, rental car, hotel, credit card membership plan, or other usage reward program.

In an alternate embodiment, reward 20 could be a certificate for a free collectable toy or novelty.

In an alternate embodiment, reward 20 could be an entertainment ticket voucher.

In an alternate embodiment, reward 20 could be a sweepstakes entry wherein access to a global networking system such as the Internet could be required for automatic electronic entry, receipt of printable entry forms, or automatic prize notification.

In an alternate embodiment, reward 20 could be a randomly variable range of rewards, wherein access to a global networking system such as the Internet could be required for the consumer to determine the specific value of his or her reward, within the specified range of possible rewards.

In an alternate embodiment, offer 22 could be printed on rear surface 44 of envelope 40, wherein instruction 28 could be printed on rear flap 42 of envelope 40.

In an alternate embodiment, offer 22 and instruction 28 could both be printed on rear flap 42 of envelope 40.

In an alternate embodiment, offer 22 and instruction 28 could both be printed on rear surface 44 of envelope 40.

In an alternate embodiment, offer 22 and instruction 28 could be printed in any location on outside envelope 40 or remittance envelope 41 or any combination thereof.

In an alternate embodiment, offer 22 and/or instruction 28 could be printed directly on a bill, statement or invoice.

In an alternate embodiment, offer 22 and/or instruction 28 could be printed on an insert, wherein the insert is provided with a bill, statement or invoice.

In an alternate embodiment, web page 60 could provide a redeemable coupon (not shown), wherein no second URL 64 is provided and no first hyperlink 66 is provided, whereby redemption of the coupon is enabled only by printing thereof.

In an alternate embodiment, web page 60 could require access to second URL 64 via first hyperlink 66 for redemption of a coupon, wherein printing thereof is not provided.

In an alternate embodiment, web page 60 could display a plurality of rewards 20, wherein a consumer could select the reward he or she prefers.

In an alternate embodiment, Provider could secure Advertiser directly, wherein Provider and/or Advertiser could perform or share the duties and services preferred by Host in the preferred embodiment.

In an alternate embodiment, Provider could receive no compensation, but could participate in return for realizing increased EBPP and/or ESP service subscriptions.

In an alternate embodiment, Advertiser or Host could choose the display location for printed offer 20.

In an alternate embodiment, Host could provide Advertiser with an appropriately selected offer message and logo.

In use, the consumer receives the printed offer, is enticed to access a global networking system such as the Internet during the bill paying or statement review process, and is induced to subscribe to EPP vendor services, such as EBPP and/or ESP, thereby receiving immediate benefit of a discounted product, service or other provided reward in return for accessing a global networking system such as the Internet. In addition, the consumer potentially gains long-term advantages from subscribing to EBPP and/or ESP systems, such as, for exemplary purposes only, reduced record keeping and budget management tasks and time expenditures.

In use, Provider is preferably a bill or statement provider, such as, for exemplary purposes only, a mortgage company, car insurance carrier, financial service provider or telecommunications company, wherein Provider receives the immediate benefit of a reduction in the cost of paper billing due to compensation received for participating in cooperative incentive and promotion system and method 10. In addition, Provider effectively promotes their EBPP and/or ESP service, provides their customer with a positive brand experience, thanks the customer with a tangible reward, reduces customer service calls, improves customer retention and increases traffic to its web site and obtains a method to directly monitor consumer behavior and response to cooperative incentive and promotion system and method 10, thereby enabling direct response thereto.

In use, EPP vendor is preferably an EBPP and/or ESP solutions provider, wherein EPP Vendor receives increased transaction fees from the acceleration of customer subscription to electronic presentment methods and increased traffic therefrom, and sustained business growth and valuation, directly impacting the long-term success of EPP vendors.

In use, Advertiser is preferably business or service provider complimentary to Provider, such as, for exemplary purposes only, a home supply company, auto service company or travel industry providers such as an airline, car rental company or hotel, wherein Advertiser receives the immediate benefit of a reduction in the cost of direct mail advertising and elimination of postage costs. In addition, Advertiser receives greater and more effective exposure than direct mail, an implied endorsement from the billing entity, an ability to directly monitor the success of the ad and, wherein the coupon relates to a web site, increased traffic thereto providing opportunities to cross sell other goods and services to the customer.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A method of encouraging subscription to electronic presentment and payment (EPP) services, comprising the steps of:
a) securing a bill or statement provider, wherein said provider receives a fee for participation in said method;
b) securing an advertiser, wherein said advertiser pays a fee for participation in said method;
c) selecting a display location for a printed offer for inclusion with said bill or statement;
d) printing said printed offer on said selected display location for inclusion with said bill or statement, wherein said printed offer comprises a reward for a product or service and direction to a first web site for activating and obtaining said reward coupon;
e) mailing said bill or statement to a consumer with said printed offer included therewith;
f) receiving of said bill or statement and said printed offer by consumer;
g) engaging of consumer in bill paying and statement review process;
h) accessing by consumer of said first web site to activate and obtain at least one reward comprising a coupon, discount, sweepstakes entry or notification of winnings and to view a link to a second web site; and
i) accessing by consumer of said second web site via hyperlink of first web site, wherein subscription to electronic bill presentment and payment (EBPP) and/or electronic statement presentment (ESP) services is enabled thereby.

2. The method of encouraging subscription to EPP services of claim 1, further comprising the step of:
c′) providing a printed offer message for participant approval.

3. The method of encouraging subscription to EPP services of claim 1, further comprising the step of:
d′) printing said printed offer on said selected display location for inclusion with said bill or statement, wherein said printed offer includes direction to a second web site for subscription to electronic bill presentment and payment (EBPP) and/or electronic statement presentment (ESP) services.

4. A method of inducing consumer subscription to electronic bill presentment and payment (EBPP) and/or electronic statement presentment (ESP) services, comprising the step of:
a) offering at least one reward to the consumer, wherein access to a global networking system such as the Internet is utilized for receipt thereof.

5. The method of inducing consumer subscription to EBPP and/or ESP services of claim 4, wherein said reward offer is displayed on at least one envelope.

6. The method of inducing consumer subscription to EBPP and/or ESP services of claim 5, wherein a first reward offer is displayed on a first said at least one envelope and a second reward offer is displayed on a second at least one envelope.

7. The method of inducing consumer subscription to EBPP and/or ESP services of claim 4, wherein said at least one reward is a discount offer.

8. The method of inducing consumer subscription to EBPP and/or ESP services of claim 4, wherein said at least one reward is a specified value credit voucher.

9. The method of inducing consumer subscription to EBPP and/or ESP services of claim 4, wherein said at least one reward is a redemption voucher for a good or service.

10. The method of inducing consumer subscription to EBPP and/or ESP services of claim 4, wherein said at least one reward is a sweepstakes entry.

11. The method of inducing consumer subscription to EBPP and/or ESP services of claim 4, wherein said access to a global networking system such as the Internet to receive said offer of said at least one reward enables consumer subscription to EBPP and/or ESP service.

12. The method of inducing consumer subscription to EBPP and/or ESP services of claim 11, wherein access to a global networking system to receive said offer is via at least one uniform resource locater (URL) specified in said offer.

13. The method of inducing consumer subscription to EBPP and/or ESP services of claim 12, wherein said at least one URL directs the consumer to a web page, said web page comprising said offer and at least one hyperlink.

14. The method of inducing consumer subscription to EBPP and/or ESP services of claim 13, wherein a first said at least one hyperlink directs the consumer to a sponsor of said offer.

15. The method of inducing consumer subscription to EBPP and/or ESP services of claim 14, wherein a second at least one hyperlink directs the consumer to a web site of a billing and statement provider.

16. The method of inducing consumer subscription to EBPP and/or ESP services of claim 15, wherein the web site of a billing and statement provider has at least one hyperlink directing a consumer to at least one EPP vendor.

17. The method of inducing consumer subscription to EBPP and/or ESP services of claim 16, wherein the consumer is awarded a subscription incentive to the consumer upon subscription to at least one EPP vendor service.

18. A method for use by a marketing host for establishing a cooperative promotion system for inducing consumer subscription to EBPP and/or ESP, comprising the steps of:
a) securing an agreement between the marketing host and at least one bill or statement provider;
b) securing an agreement between the marketing host and at least one promotional sponsor;
c) providing a fee from said at least one promotional sponsor to the marketing host;
d) providing compensation from the marketing host to said at least one provider for cooperative participation in said promotion method.

19. The method of establishing a cooperative promotion system of claim 18, further comprising the step of:
e) enabling monitoring of performance of said cooperative promotion system.

20. The method of establishing a cooperative promotion system of claim 19, wherein said monitoring of performance of said cooperative promotion system comprises tracking of access to at least one URL.

21. The method of establishing a cooperative promotion system of claim 20, further comprising the step of:
f) enabling downloading of said monitoring data.

22. The method of establishing a cooperative promotion system of claim 18, further comprising the steps of:
b′) securing an agreement between the marketing host and at least one EBPP or ESP provider;
b″) receiving a fee from said at least one EBPP or ESP provider to the marketing host;
c′) providing a compensation from the marketing host to said at least one EBPP or ESP provider for cooperative participation in said promotion method.

23. The method of establishing a cooperative promotion system of claim 18, further comprising the step of:
a′) receiving a fee from said at least one provider to the marketing host.

24. A method of consumer subscription to electronic bill payment, comprising the steps of:
a) printing a reward advertisement on an envelope, wherein said reward advertisement promotes at least one reward and directs the consumer to a global network website; and
b) providing a link on said global network website to an electronic bill payment service.
